(19) United States
(12) Patent Application Publication
(10) Pub. No.: US 2015/0142731 A1
(43) Pub. Date: May 21, 2015

(54) SYSTEM FOR SAVING SENSING DATA, APPARATUS FOR SAVING DATA, METHOD FOR SAVING DATA

(71) Applicant: Electronics and Telecommunications Research Institute, Daejeon (KR)

(72) Inventors: Yoon-Sik YOO, Daejeon (KR); Dong-Hwan PARK, Daejeon (KR); Hyo-Chan BANG, Daejeon (KR)

(21) Appl. No.: 14/543,611

(22) Filed: Nov. 17, 2014

(30) Foreign Application Priority Data
Nov. 19, 2013 (KR) 10-2013-0140899
Oct. 14, 2014 (KR) 10-2014-0138580

(51) Int. Cl. G06F 17/30

(52) U.S. Cl. CPC G06F 17/30345; G06F 17/30386; G06F 17/30091
USPC 707/609; 707/736

(57) ABSTRACT

A system for saving data according to an embodiment of the present invention comprises an apparatus for data collecting data generated from a sensor; an apparatus for saving data saving the data in database corresponding to a cumulative data table and a latest data table; an apparatus for providing data transmitting a request for retrieval of data to the apparatus for saving data and obtaining the data saved in the cumulative data table or the latest data table according to the request; and an apparatus for serving data providing the data to a user's terminal.

### CROSS REFERENCE TO RELATED APPLICATION

This application claims the benefit of Korean Patent Application No. 10-2013-0140899, filed on Nov. 19, 2013, entitled “System architecture for Large scale sensing data of things” and Korean Patent Application No. 10-2014-0138580, filed on Oct. 14, 2014, entitled “System for saving sensing data, apparatus for saving data, method for saving data”, which is hereby incorporated by reference in its entirety into this application.

### BACKGROUND OF THE INVENTION

1. Technical Field

The present invention relates to a system and method for saving big sensing data which stores and provides sensing data collected by things themselves or sensing information for things measured by sensors in a cloud system in real time.

2. Description of the Related Art

In response to rapidly growing demands for connections through Internet of Things (IoT), it is needed to develop a method for saving sensing data collected by things or data of things measured by sensors in the cloud system and providing the data efficiently to users. It is expected that the amount of data will exponentially increase with accumulation of sensing data measured and stored for various things which are connected through the internet in the cloud system. It is thus expected that a system for efficiently saving and providing such data is needed.

A great deal of development research is under way on data distribution and collection, processing, management and distributed parallel processing of big data by implementing a big cluster to process big data in the already-built cloud environment. Among them, distributed database for storing formalized data is called as Not Only SQL (NoSQL) and typical examples of the NoSQL system include MongoDB, Cassandra and the like. BigTable is a data storage system built on Google file system of which construction and data processing method have been published. HBase, which is an open source, is developed by the open source group Apache and modeled after Google's BigTable. Google uses a MapReduce programing module for processing and analyzing large data. Hadoop, which is developed by Apache, is an open source and allows for the distributed processing of big data.

### SUMMARY OF THE INVENTION

An object of the present invention is to provide a system and method for saving data which saves sensing data collected by an object or data for an object collected by a sensor in a cloud system, opening the data on the internet, and retrieving and providing the result.

According to an aspect of the present invention, there is provided a system for saving sensing data comprising: an apparatus for data collecting data generated from a sensor; an apparatus for saving data saving the data in database corresponding to a cumulative data table and a latest data table; an apparatus for providing data transmitting a request for retrieval of data to the apparatus for saving data and obtaining the data saved in the cumulative data table or the latest data table according to the request; and an apparatus for serving data providing the data to a user's terminal.

The system for saving sensing data may further comprise an apparatus for analyzing data transmitting a request for retrieval of data to the apparatus for saving data, receiving the retrieved data according to the request from the apparatus for saving data, analyzing the retrieved data by a predetermined method, and generating the analyzed data.

The cumulative data table may be a table using data identification information of the data as a key and the latest data table may be a table using sensor identification information of the data as a key.

The apparatus for saving data may update a row of the latest data table corresponding to the sensor identification information of the data according to the data.

According to another aspect of the present invention, there is provided an apparatus for saving data comprising: a communication interface receiving data through network; a processor saving or retrieving the data according to a predetermined program; and a memory saving the program, wherein the program may, when it is executed in the processor, let the apparatus for saving data to issue data identification information for the inputted data, save the inputted data in a cumulative data table and a latest data table, receive a request for retrieval of data, retrieve, when the request requests the latest data, the data from the latest data table by using the sensor identification information of the data, and output the data.

The cumulative data table may be a table using data identification information of the data as a key; and the latest data table may be a table using sensor identification information of the data as a key.

The program may, when it is executed in the processor, let the apparatus for saving data to update a row of the latest data table corresponding to the sensor identification information of the inputted data, when the row of the latest data table corresponding to the sensor identification information of the inputted data is present.

The program may, when it is executed in the processor, let the apparatus for saving data to generate a row of the latest data table corresponding to the sensor identification information of the inputted data when the row of the latest data table corresponding to the sensor identification information of the inputted data is not present.

The program may, when it is executed in the processor, let the apparatus for saving data to generate a row of the cumulative data table corresponding to the data identification information of the inputted data.

The program may, when it is executed in the processor, let the apparatus for saving data to retrieve retrieving data from the cumulative data table by using the sensor identification information of the data when the request is not the request for the latest data.

According to still another aspect of the present invention, there is provided a method for saving data by an apparatus for saving data, the method comprising: issuing data identification information for inputted data; saving the inputted data in a cumulative data table and a latest data table; receiving a request for retrieval of data; retrieving data from the latest data table by using the sensor identification information of the data when the request requests for the latest data; and outputting the retrieved data.

The cumulative data table may be a table using data identification information of the data as a key and the latest data table may be a table using sensor identification information of the data as a key

The step for saving the inputted data in a cumulative data table and a latest data table may comprise updating a row of the latest data table corresponding to the sensor identification information of the inputted data according to the inputted data when the row of the latest data table corresponding to the sensor identification information of the inputted data is present.

The step for saving the inputted data in a cumulative data table and a latest data table may comprise generating a row of the latest data table corresponding to the sensor identification information of the inputted data when the row of the latest data table corresponding to the sensor identification information of the inputted data is not present.

The step for saving the inputted data in a cumulative data table and a latest data table may comprise generating a row of the cumulative data table corresponding to the data identification information of the inputted data.

The method for saving data may further comprise retrieving for retrieving data from the cumulative data table by using the sensor identification information of the data when the request is not for the latest data.

The present invention allows storing big sensing data in the cloud system and providing such data to a user through the network.

The present invention also allows efficiently retrieving data according to a request which requests for cumulative data to be used for analysis or requests only for the latest data when sensing data is inquired since big data is stored separately in the cumulative data table and the latest data table.

### BRIEF DESCRIPTION OF DRAWINGS

FIG. 1 illustrates a system for saving sensing data according to an embodiment of the present invention.

FIG. 2 is a block view illustrating an apparatus for saving data according to an embodiment of the present invention.

FIG. 3 is a flowchart illustrating a method for saving and retrieving data by an apparatus for saving data according to an embodiment of the present invention.

FIG. 4 illustrates a cumulative data table of which cumulative data is stored by an apparatus for saving data according to an embodiment of the present invention.

FIG. 5 illustrates the latest data table of which the latest data is stored by an apparatus for saving data according to an embodiment of the present invention.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted. While such terms as “first” and “second,” etc., may be used to describe various components, such components must not be limited to the above terms. The above terms are used only to distinguish one component from another.

When one element is described as being “connected” or “accessed” to another element, it shall be construed as being connected or accessed to the other element directly but also as possibly having another element in between.

Hereinafter, certain embodiments of the present invention will be described with reference to the accompanying drawings. In descriptions of components of the invention, the same reference numeral may be assigned to the same component regardless of drawing number in order to facilitate a thorough understanding.

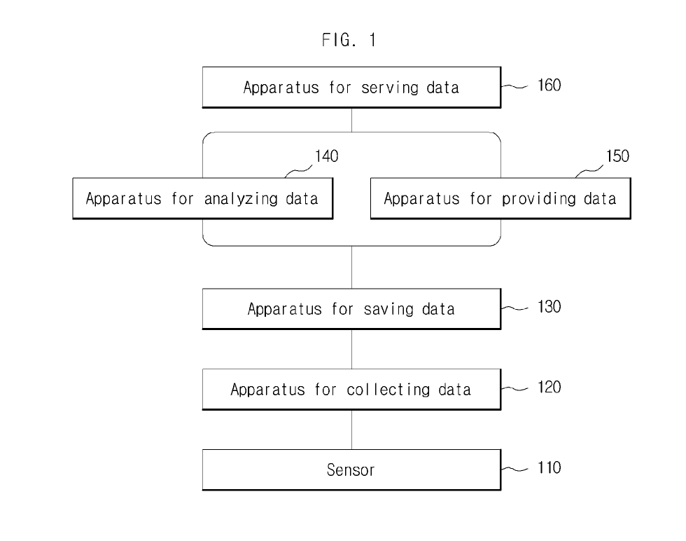

FIG. 1 illustrates a system for saving sensing data according to an embodiment of the present invention.

Referring to FIG. 1, the system for saving sensing data may include a sensor 110, an apparatus for collecting data 120, an apparatus for saving data 130, an apparatus for analyzing data 140, an apparatus for providing data 150, and an apparatus for serving data 160.

The sensor 110 generates predetermined data by measuring the environment. For example, the sensor 110 determines temperature and then generates data including the measured temperature. The sensor 110 may be implemented to generate a variety of data by a known method. Even though FIG. 1 only illustrates a single sensor 110 which is connected to the system for saving sensing data, a plurality of sensors 110 may be included in the system for saving sensing data.

The apparatus for collecting data 120 receives data from the sensor 110 and converts the data into the format which can be stored in the apparatus for saving data 130. The apparatus for collecting data 120 transmits the converted data to the apparatus for saving data 130. Here, the apparatus for collecting data 120 may receive data from each sensor 110 through a known HTTP protocol.

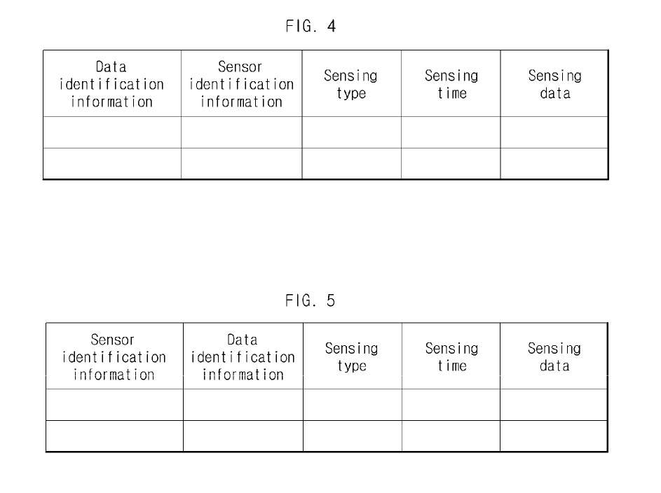

The apparatus for saving data 130 stores the data received from the apparatus for collecting data 120. The apparatus for saving data 130 may include a cumulative data table and a latest data table. Here, the cumulative data table is a database table which stores all data produced by each sensor 110 during different time. The latest data table is a database table which stores only the latest data produced by each sensor 110. Thus, the apparatus for saving data 130 may, when data is received from the apparatus for collecting data 120, store the received data in the cumulative data table and the latest data. The apparatus for saving data 130 may, when previous data is stored in the latest data table, update the latest table by saving the received data. The cumulative data table and the latest data table will be described in more detail below with reference to FIG. 4 and FIG. 5. The apparatus for saving data 130 may include a NoSQL-based distributed data storage. Since a number of objects may be present around the sensor 110 and the sensor 110 generates data by sensing such number of objects for a long period of time, the data generated by the sensor 110 may be big. Therefore, it is necessary to store the big data generated from the plurality of sensors 110 in a distributed storage system and to facilitate expansion of additional nodes, if needed. The apparatus for saving data according to an embodiment of the present invention 130 may be a distributed data saving system including a NoSQL-based distributed data storage implemented through at least one node.

The apparatus for analyzing data 140 is composed with a set of predefined MapReduce implemented objects and provides a MapReduce function. The MapReduce function provided by the apparatus for analyzing data 140 collects data from each node of the NoSQL-based apparatus for saving data 130 and generates analysis data through a predetermined process for analyzing the collected data. The analysis data may be data including information obtained by determining the collected data according to the predetermined process.

Accordingly, the apparatus for analyzing data 140 may, when a request for analysis data is received from the apparatus for serving data 160, generate the analysis data and transmit it to the apparatus for serving data 160. For example, the apparatus for analyzing data 140 may generate analysis data including statistics such as a minimum value, a maximum value, an average value and a median value. Here, the apparatus for analyzing data 140 may obtain data by transmitting a request for the data to the apparatus for saving data 130. In addition, the apparatus for analyzing data 140 may request for the latest data to the apparatus for saving data 130. Here, the latest data is the data lately received and stored by each sensor 110.

The apparatus for providing data 150, when a signal requesting for collecting raw data (hereinafter, referred to as request for raw data) is received from the apparatus for serving data 160, requests to the NoSQL-based apparatus for saving data 130. The apparatus for providing data 150 receives data for the request from the apparatus for saving data 130 and transmits the received data to the apparatus for serving data 160. Here, unlike the apparatus for analyzing data 140 which generates analysis data including statistics for the data, the apparatus for providing data 150 transmits all the data collected for a certain period of time to the apparatus for serving data 160. Here, the apparatus for providing data 150 may obtain data by requesting for the data to the apparatus for saving data 130. The apparatus for providing data 150 may also transmit a request for the latest data to the apparatus for saving data 130.

The apparatus for serving data 160 may receive a user's request for data from a user's terminal through a predetermined protocol and transmit a request for analysis data for the requested data to the apparatus for analyzing data 140 or a request for raw data to the apparatus for providing data 150. Here, the apparatus for serving data 160 may receive a user's request requesting for analysis data or raw data through a user interface included in a webpage.

Therefore, the system for saving sensing data according to an embodiment of the present invention stores big data generated by the sensor(s) 110 and provides data through a protocol, to which a user's terminal is easily accessible (e.g., HTTP protocol), to the user's terminal.

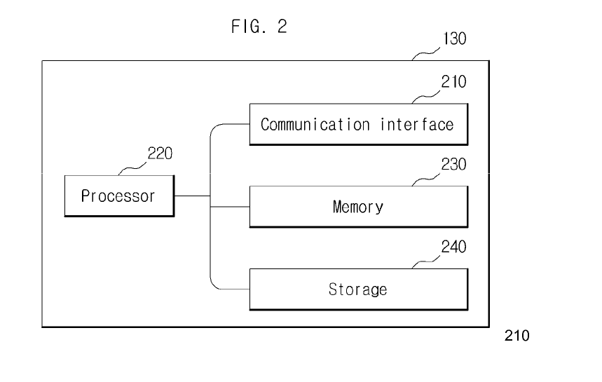

FIG. 2 is a block view illustrating an apparatus for saving data according to an embodiment of the present invention. The apparatus for saving data 130 to be described below is one of a plurality of nodes and when the apparatus for saving data 130 is implemented with more than one, those nodes may have structure being connected each other.

Referring to FIG. 2, the apparatus for saving data 130 may include a communication interface 210, a processor 220, a memory 230 and a storage 240.

The communication interface 210 receives/transmits data through network by being connected with the apparatus for collecting data 120, the apparatus for analyzing data 140 and the apparatus for providing data 150.

The processor 220 may store the data received from the apparatus for collecting data 120 in the cumulative data table and the latest data table according to a predetermined program. The processor 220 may retrieve the data stored in the cumulative data table and the latest data table and provide the retrieved data to the apparatus for collecting data 120 or the apparatus for analyzing data 140.

The memory 230 stores the predetermined program for storing and retrieving the data. The memory 230 may be a volatile memory such as a random access memory (RAM).

The storage 240 includes database according to the cumulative data table and the latest data table. The processor 220 may thus store or retrieve data by using the cumulative data table and the latest data table.

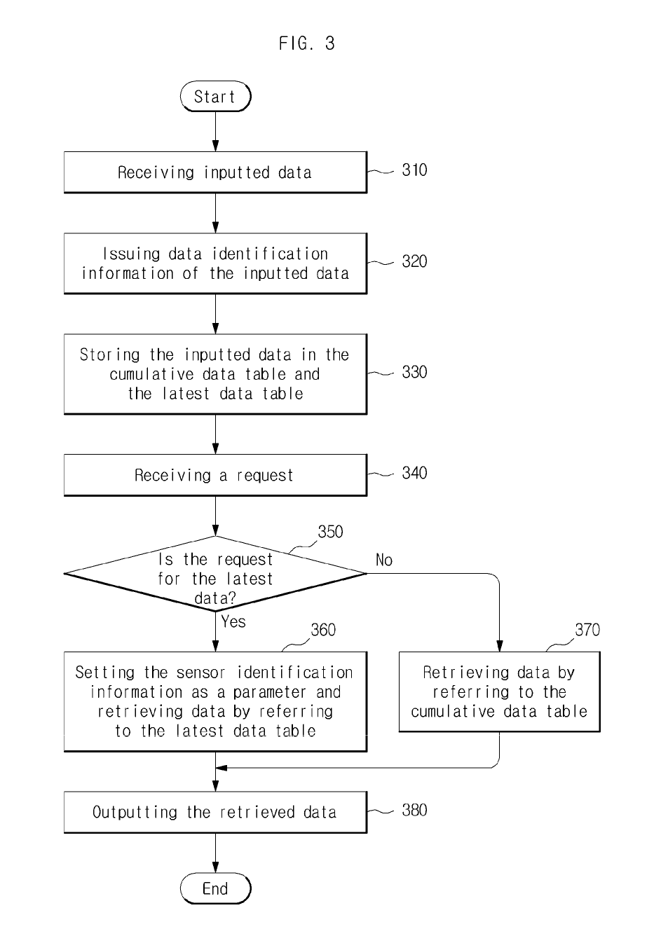

A process for storing and retrieving data by the apparatus for saving data 130 will be described hereinafter with reference to FIG. 3.

FIG. 3 is a flowchart illustrating a method for saving and retrieving data by an apparatus for saving data according to an embodiment of the present invention. Processes performed according to the program stored in the memory 230 by the processor 220 of the apparatus for saving data 130 or general processes performed by a computer referring programs of the memory for clear and brief description of the present invention may be omitted.

Referring to FIG. 3, in Step 310, the apparatus for saving data 130 receives data (hereinafter, the received data is referred to as inputted data) from the apparatus for collecting data 120. Here, the inputted data may include identification information of the sensor 110 which generates the corresponding data (referred to as sensor identification information).

In Step 320, the apparatus for saving data 130 issues identification information of the inputted data. The identification information issued for the inputted data is referred to as data identification information.

In Step 330, the apparatus for saving data 130 stores the inputted data in database of the cumulative data table and the latest data table. Here, the apparatus for saving data 130 may store the data in a new row of the cumulative data table. In addition, the apparatus for saving data 130 may, when a row including sensor identification information is present in the latest data table, update the corresponding row according to the data received in Step 310. On the other hand, the apparatus for saving data 130 may, when a row including sensor identification information is not present in the latest data table, generate a new row corresponding to the data and store the data. Structure of the cumulative data table and the latest data table will be described with reference to FIG. 4 and FIG. 5.

In Step 340, the apparatus for saving data 130 receives a request from the apparatus for analyzing data 140 or the apparatus for providing data 150.

In Step 350, the apparatus for saving data 130 determines if the request received in Step 340 requests for the latest data or not (which is if the request requests only the latest data).

When it is determined in Step 350 that the request requests for the latest data, in Step 360, the apparatus for saving data 130 sets the sensor identification information as a parameter and retrieves data by referring to the latest data table. Here, the latest data table may be a table sorted by sensor identification information as a key. Therefore, the apparatus for saving data 130 may quickly perform retrieval for the latest data received from the particular sensor 110.

When it is determined in Step 350 that the request does not request for the latest data, in Step 370, the apparatus for saving data 130 retrieves data by referring to the cumulative data table.

In Step 380, the apparatus for saving data 130 transmits the data retrieved in Step 360 or in Step 370 to the apparatus for analyzing data 140 or the apparatus for providing data 150.

FIG. 4 illustrates a cumulative data table of which cumulative data is stored by an apparatus for saving data according to an embodiment of the present invention and FIG. 5 illustrates the latest data table of which the latest data is stored by an apparatus for saving data according to an embodiment of the present invention.

Referring to FIG. 4, the cumulative data table may include columns corresponding to data identification information, sensor identification information, sensing type, sensing time, sensing data and the like, in which the sensing type means type of information collected by sensors detecting temperature, humidity, illumination and the like, the sensing data means data including values which is calculated by determining a particular object or environment by sensors, and the sensing time means time when sensing data is generated. The data generated by the sensor 110 and transmitted to the apparatus for collecting data 120 may include the sensor identification information, the sensing type, the sensing time and the sensing data. Furthermore, the cumulative data table may be a table sorted by data identification information as a key. The apparatus for saving data 130 may thus store a plurality of data generated by the same sensor 110 in the cumulative data table.

The latest data table may include columns corresponding to sensor identification information, data identification information, sensing type, sensing time, sensing data and the like, in which the latest data table may be a table set by the sensor identification information as a key. The apparatus for saving data 130 may, when a request including particular sensor identification information is received, thus quickly retrieve data corresponding to the sensor identification information by referring to the latest data table.

Therefore, the system for saving sensing data according to an embodiment of the present invention may, when the latest data is retrieved, set the sensor identification information as a parameter, retrieve data by referring to the latest data table, which is set by the sensor identification information as a key, and provide the result.

In addition, the system for saving sensing data may, when a request for retrieving data other than the latest data, retrieve the columns of the cumulative data table corresponding to the sensor identification information and provide not only the latest data but also cumulated data even though retrieving speed is slow.

The method for saving data of the present invention can be implemented by the method which the computer is implemented or in non-volatile computer recording media stored in computer executable instructions. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for saving sensing data comprising:
an apparatus for data collecting data generated from a sensor;
an apparatus for saving data saving the data in database corresponding to a cumulative data table and a latest data table;
an apparatus for providing data transmitting a request for retrieval of data to the apparatus for saving data and obtaining the data saved in the cumulative data table or the latest data table according to the request; and
an apparatus for serving data providing the data to a user's terminal.

2. The system for saving sensing data of claim 1, further comprising an apparatus for analyzing data transmitting a request for retrieval of data to the apparatus for saving data, receiving the retrieved data according to the request from the apparatus for saving data, analyzing the retrieved data by a predetermined method, and generating the analyzed data.

3. The system for saving sensing data of claim 1, wherein the cumulative data table is a table using data identification information of the data as a key; and
the latest data table is a table using sensor identification information of the data as a key.

4. The system for saving sensing data of claim 3, wherein the apparatus for saving data updates a row of the latest data table corresponding to the sensor identification information of the data according to the data.

5. An apparatus for saving data comprising:
a communication interface receiving data through network;
a processor saving or retrieving the data according to a predetermined program; and
a memory saving the program,
wherein the program, when it is executed in the processor, lets the apparatus for saving data to
issue data identification information for the inputted data,
save the inputted data in a cumulative data table and a latest data table,
receive a request for retrieval of data,
retrieve, when the request requests for the latest data, the data from the latest data table by using the sensor identification information of the data, and
output the data.

6. The apparatus for saving data of claim 5, wherein the cumulative data table is a table using data identification information of the data as a key; and
the latest data table is a table using sensor identification information of the data as a key.

7. The apparatus for saving data of claim 6, wherein the program, when it is executed in the processor, lets the apparatus for saving data to update a row of the latest data table corresponding to the sensor identification information of the inputted data, when the row of the latest data table corresponding to the sensor identification information of the inputted data is present.

8. The apparatus for saving data of claim 7, wherein the program, when it is executed in the processor, lets the apparatus for saving data to generate a row of the latest data table corresponding to the sensor identification information of the inputted data when the row of the latest data table corresponding to the sensor identification information of the inputted data is not present.

9. The apparatus for saving data of claim 6, wherein the program, when it is executed in the processor, lets the apparatus for saving data to generate a row of the cumulative data table corresponding to the data identification information of the inputted data.

10. The apparatus for saving data of claim 5, wherein the program, when it is executed in the processor, lets the apparatus for saving data to retrieve for retrieve data from the cumulative data table by using sensor identification information of the data when the request is not the request for the latest data.

11. A method for saving data in a method for saving inputted data by an apparatus for saving data, the method comprising:
issuing data identification information for inputted data;
saving the inputted data in a cumulative data table and a latest data table;
receiving a request for retrieval of data;
retrieving data from the latest data table by using the sensor identification information of the data when the request requests for the latest data; and
outputting the retrieved data.

12. The method for saving data of claim 11, wherein the cumulative data table is a table using data identification information of the data as a key; and
the latest data table is a table using sensor identification information of the data as a key.

13. The method for saving data of claim 11, wherein the step for saving the inputted data in a cumulative data table and a latest data table comprises updating a row of the latest data table corresponding to the sensor identification information of the inputted data according to the inputted data when the row of the latest data table corresponding to the sensor identification information of the inputted data is present.

14. The method for saving data of claim 13, wherein the step for saving the inputted data in a cumulative data table and a latest data table comprises generating a row of the latest data table corresponding to the sensor identification information of the inputted data when the row of the latest data table corresponding to the sensor identification information of the inputted data is not present.

15. The method for saving data of claim 12, wherein the step for saving the inputted data in a cumulative data table and a latest data table comprises generating a row of the cumulative data table corresponding to the data identification information of the inputted data.

16. The method for saving data of claim 11, further comprising retrieving retrieve data from the cumulative data table by using sensor identification information of the data when the request is not for the latest data.
